(19) United States
(12) Patent Application Publication
(10) Pub. No.: US 2015/0136840 A1
(43) Pub. Date: May 21, 2015

(54) METHOD OF JOINING STACKS OF THIN METAL FOIL LAYERS

(71) Applicant: MEDTRONIC, INC., Minneapolis, MN (US)

(72) Inventors: Hailiang Zhao, Maple Grove, MN (US); Erik J. Hovland, Minnetonka, MN (US)

(73) Assignee: MEDTRONIC, INC., Minneapolis, MN (US)

(21) Appl. No.: 14/085,833

(22) Filed: Nov. 21, 2013

(51) Int. Cl. B23K 26/32; B23K 31/02; B23K 20/00; H01M 4/04

(52) U.S. Cl. CPC B23K 26/3293; H01M 4/04; B23K 26/3226; B23K 31/02; B23K 20/002
USPC 228/160; 219/121.64; 29/879; 228/190

(57) ABSTRACT

Disclosed are methods of welding a stack of metal foil layers together using a penetration weld. The methods include stacking of the metal foil layers, pressing or compressing the metal foil layers between end plates and welding the end plates and compressed metal foil layer stack together.

### BACKGROUND

The disclosure relates to methods of joining thin metal foil layers together to form joined stacks that are electrically conductive, for example, a stack of electrically conductive tabs for electrodes for an electrochemical cell.

Stacked plate electrochemical cells contain layers of metal foils or coated metal foils that are stacked upon one another. Typically, such stacked metal foils have tabs that are joined together at a common location to form an electrical contact point. Welding the stack of metal foil tabs together using penetration or edge welding techniques is difficult due to the difficulty in fixturing the individual layers tightly together with no gaps in between any of the layers. Gaps in between the layers can cause the individual layer to burn or to not melt completely through.

### SUMMARY

The present disclosure discloses methods of welding stacks of metal foil layers together. In one embodiment, the method includes stacking a plurality of metal foil layers to form a metal foil layer stack, the metal foil layer stack having a width, a length, and a metal foil layer stack edge, sandwiching the metal foil layer stack between top and bottom end plates, aligning the edges of the top and bottom end plates with the edge of the metal foil layer stack and pressing or compressing the metal foil layers together between the top and bottom end plates and welding the metal foil layer stack and the top and bottom end plates together.

In certain embodiments, the thickness of the end plates is at least 20 micrometers thick. In certain embodiments, the welding of the metal foil layer stack and the top and bottom end plates together is a penetration weld. In certain embodiments, the penetration weld is a laser penetration weld.

### BRIEF DESCRIPTION OF THE DRAWINGS

FIG. 1 is a depiction of a stack of electrodes.

FIG. 2 is a depiction of a stack of electrodes wherein the tabs of the electrodes are gathered.

FIG. 3 is a plan view depiction of an end plate.

FIG. 4 is a perspective view depiction of an end plate.

FIG. 5 is a depiction of a stack of electrodes wherein the tabs of the electrodes are gathered and the metal foil stack edge is aligned with the edges of the end plates.

FIG. 6 is a depiction of a welded metal foil layer stack from the laser contact side.

FIG. 7 is a depiction of a welded metal foil layer stack from the opposite side that is shown in FIG. 6.

FIG. 8 is a depiction of a use of a resulting stack of individual electrodes after having been stacked and welded.

FIG. 9 is a depiction of the parts of an embodiment of a fixture assembly.

FIG. 10 is a depiction of an embodiment of a partially assembled fixture assembly containing a stack of metal foil layers.

### DETAILED DESCRIPTION

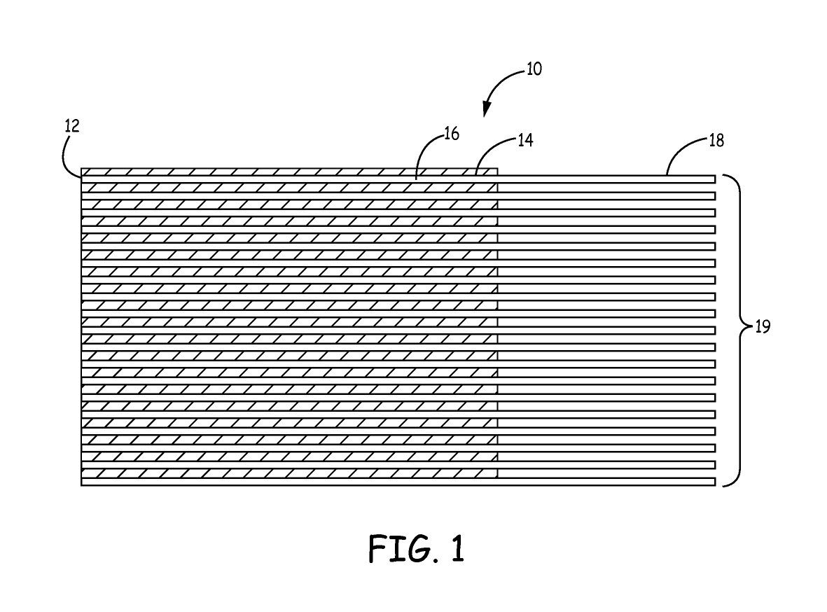

FIG. 1 is a side view of a depiction of a stack of electrodes that can be used in an electrochemical cell. Electrode stack 10 comprises individual electrodes 12 assembled into a stack. Each electrode 12 comprises an electrode material 14 coated onto a metal foil layer 16. Each metal foil layer 16 has a tab portion or tab 18 that is not coated with electrode material. Typically, each electrode 12 in the electrode stack has a tab 18 that is intended to be identical in location, length, width and thickness so that the individual tabs are aligned when the individual electrodes are stacked to form a metal foil layer stack 19. The electrode stack may also have separator layers or separators (not shown) and electrodes of a second (opposing) polarity (not shown) appropriately placed between electrode layers, for example around the cathode material. The separator layers can be in the form of a sheet, wrap, bag or the like.

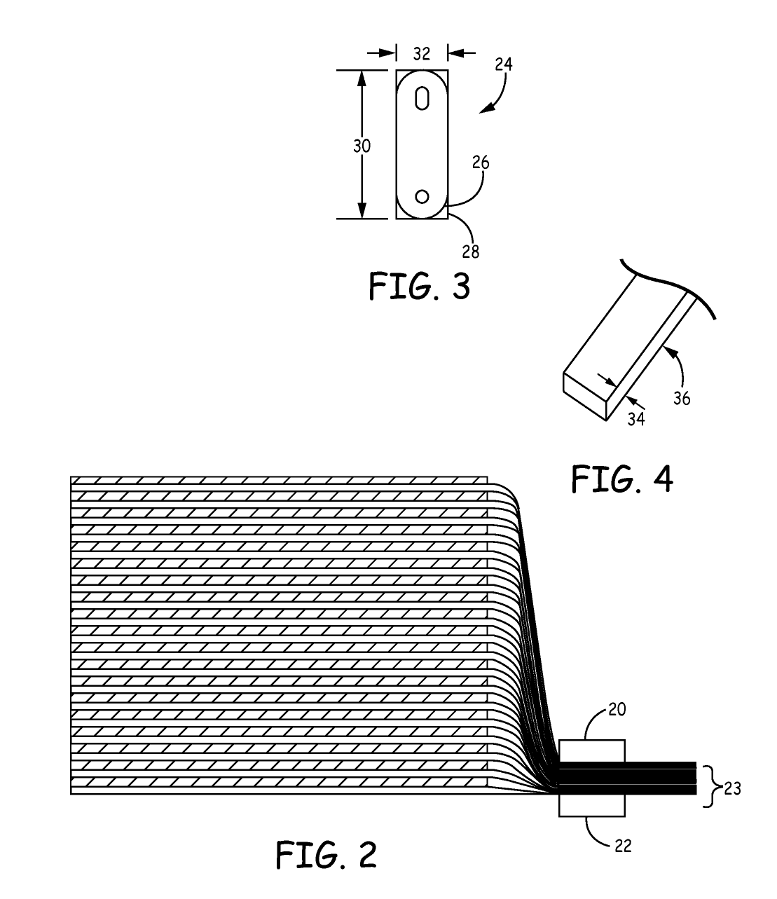

Once the electrodes 12 are stacked, tabs 18 of the metal foil layers are gathered together by pressing or compressing the tabs of the metal foil layers together and then sandwiched between top or first and bottom or second end plates 20, 22 as shown in FIG. 2. FIG. 3 is a top or plan view of an embodiment of an end plate 24. As shown in FIG. 3, each end plate 24 may have rounded edges 26 or square edges 28. Referring to FIGS. 3 and 4, each endplate has a length 30, width 32 and thickness 34 defined by the edges 36 of the endplates.

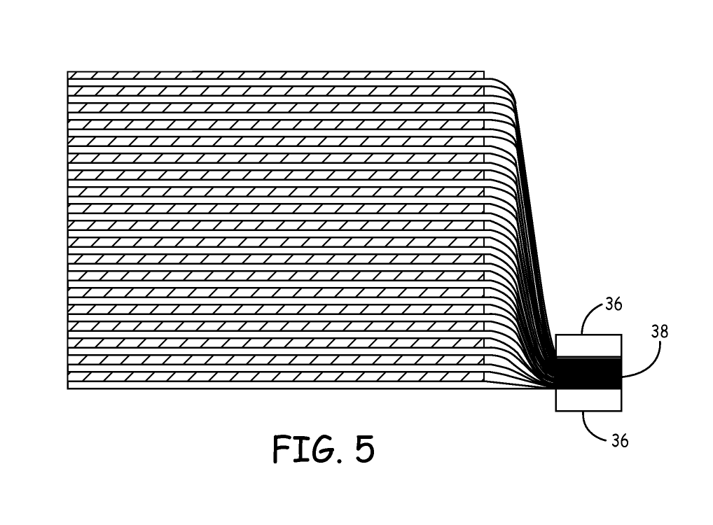

Referring to FIG. 5, the metal foil stack edge 38 is aligned with the edges 36 of the end plates. Typically, the edges of the end plates 36 and the edges of the foil stack 38 are aligned by trimming or cutting any excess metal foil layer that extends beyond the aligned edges of the end plates. The end plates are pressed or compressed together to form a compressed metal foil layer stack 23 and then the end plates are welded to the compressed metal foil layer stack and to one another. Once welded, the stacks are electrically conductive.

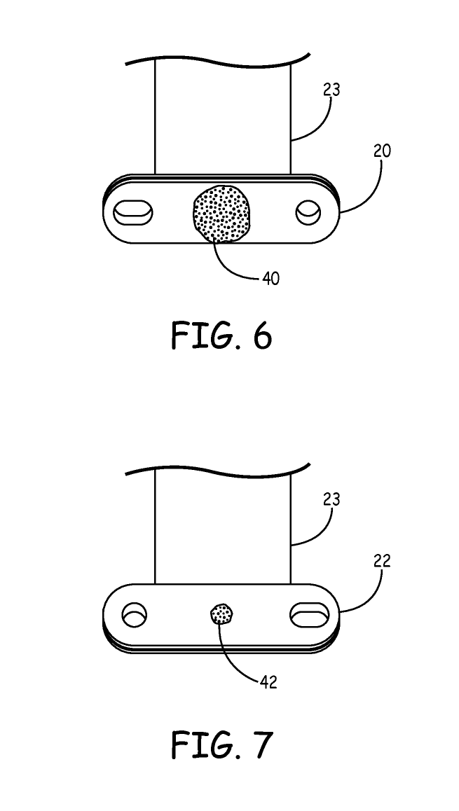

FIGS. 6 and 7 are depictions of end plates 20, 22 welded together and to the metal foil layer stack 23. As can be seen in FIGS. 6 and 7, the penetration weld 40 (welded from the bottom side) penetrates through the bottom end plate 20, the compressed metal foil layer stack, and the top end plate 22 as evidenced by weld mark 42. Typically, the length 30 of the end plates is about equal to the width of the metal foil layer stack 23.

The metal foil layers can be made from any electrically conductive and weld-able materials. Examples of such materials are copper, aluminum nickel, titanium or alloys of or containing any of them. The thickness of the metal foil layers range from 5 micrometers to 40 micrometers, in other embodiments, from 10 micrometers to 20 micrometers. The range from 5 micrometers to 40 micrometers is intended to include any range or value within the range of 5 to 40 micrometers.

The metal foil layers in some embodiments may be partially coated with a coating, for example, an active coating for an electrode. The coating thickness may range from 25 micrometers to about 250 micrometers. In other embodiments, the coating thickness may range from 50 micrometers to 125 micrometers. The range from 25 micrometers to 250 micrometers is intended to include any range or value within the range of 25 to 250 micrometers.

Stacks of coated metal foil sheets can contain as many layers or sheets as desired, provided that the compressed foil layer sheet stack and the end plates can be adequately welded together. In specific embodiments, coated aluminum and copper metal foil sheets can contain up to 20, up to 16, or up to 14 layers each, and may range from 1 each to 20 each, including any range or number in between 1 and 20. The total number of coated metal foil layers ranges from up to 40 layers, up to 32 layers, or up to 28 layers.

The end plates can also be made from any electrically conductive and weld-able materials. Examples of such materials are metals comprising titanium, vanadium, aluminum, nickel or alloys of or containing any of them. Within this group, the end plates should be made from a metal that is metallurgically compatible with the metal of the metal foil layers and stack. Typically, the end plates have a thickness of at least 20 micrometers. In other embodiments, the end plates have a thickness of at least 20 micrometers or 2× the thickness of the compressed metal foil layer stack, whichever is less. The end plates should also be thick enough to be rigid enough to transfer clamping or compression forces to eliminate gaps between the individual metal foil layers before welding.

The end plates and the compressed metal foil layer stack are welded together using a penetration weld. A penetration weld is defined as “a weld that melts through the entire thickness of the welded part.” Typically, a laser penetration welding process is used. Desirably, the top end plate has low electrical resistivity in order to provide adequate coupling of the laser energy. For example, a top end plate made of or comprising nickel could be used to weld a metal foil layer stack made from copper metal foil layers. The bottom plate may also have low electrical resistivity, but it is not required of the bottom end plate. Otherwise, the requirements of the bottom end plate are identical to the requirements of the top end plate.

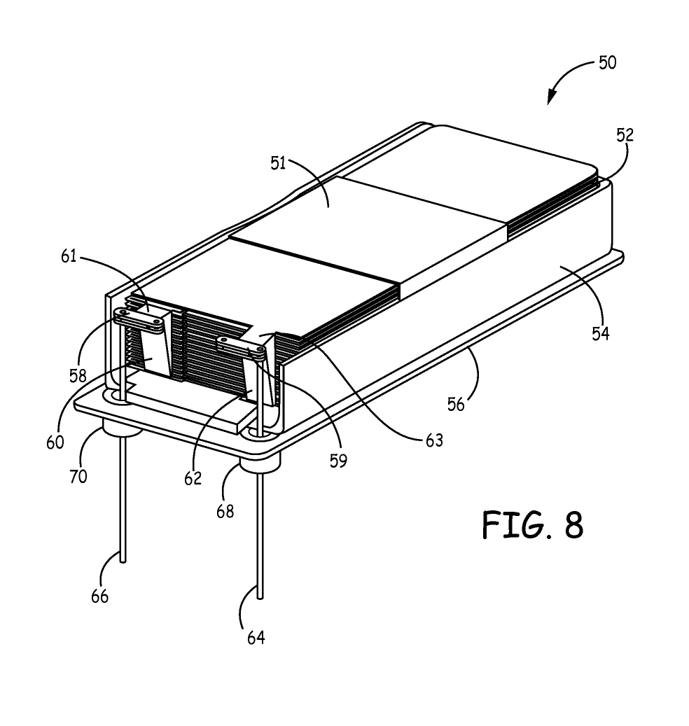

FIG. 8 is a depiction of a typical use of a resulting stack of individual electrodes after having been stacked and welded as described above. Electrochemical cell assembly 50 includes an electrode stack 52 within a thermal insulator 54. The electrode stack is wrapped or secured by an insulative barrier 51, for example, a flexible backing material coated with an adhesive. In this depiction, the thermal insulator containing the electrode stack is oriented on top of the case cover 56. The electrode stack has two sets of end plates 58, 59 where each set of end plates is welded to a compressed metal foil layer stack 60, 62 to form welded metal foil layer stack and end plate assemblies 61, 63. Attached to each welded metal foil layer stack and end plate assembly through attachment to the end plates 20 is a feedthrough pin 64, 66. Each feedthrough pin extends from each welded end plate 20 through a feedthrough 68, 70 and outside of the cover. As shown in FIG. 8, the position of each pair of welded end plates is aligned such that the feedthrough pin when welded to the welded end plates aligns with the bore in each feedthrough.

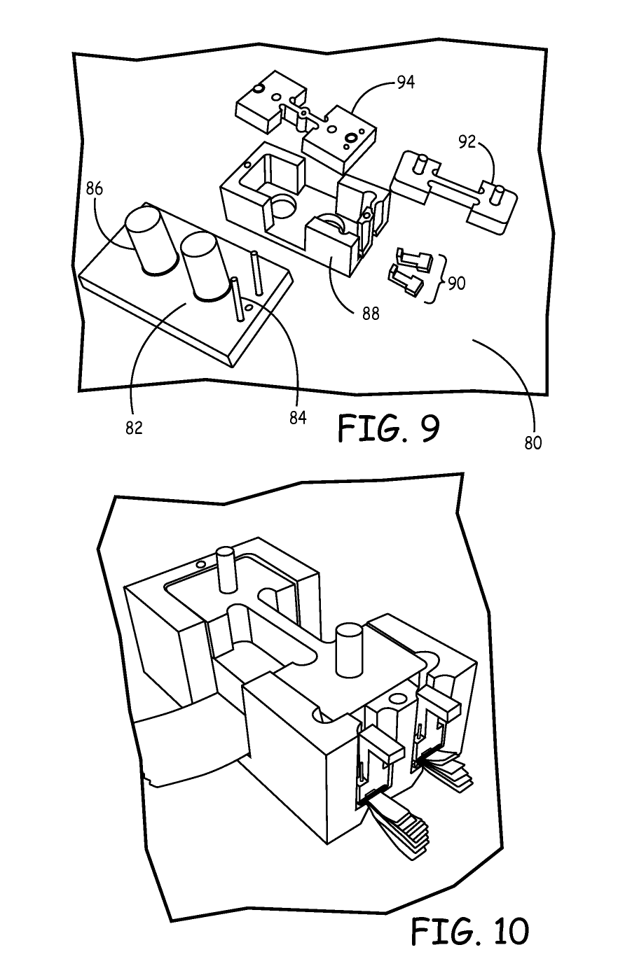

FIG. 9 is an example of the parts of a fixture used to assemble a stack of metal foil layers. Fixture assembly 80 comprises a metal foil layer stack ejector assembly 81, a stacking nest 88 with alignment pins 89 (shown in FIG. 10), tab gatherers 90, a stack plunger 92 and a clamp plate 94. Stack ejector assembly includes an ejector base plate 82, small ejector pins 84 and large ejector pins 86.

In use, an end plate is fitted over the alignment pins 89 and the metal foil layers are stacked within the stacking nest 88 with the tabs extending out through channels 83 in the stacking nest. Another end plate is fitted over the alignment pins and placed on top of the stack of tabs. The tab gatherers 90 and stack plunger 92 are fixed on the alignment pins and over the stacked metal foil layers and within the stacking nest 88, respectively.

The clamp plate 94 is placed over the stack plunger and tightened down which applies a load to the stack plunger and the tab gatherers. The excess metal foil layer tab material is trimmed prior to welding. The fixture assembly with the stacked metal foil layers can be placed onto a welding fixture which aligns the compressed end plate and metal foil layer tabs with a laser welding head. In this embodiment, a fully assembled fixture assembly with the metal foil layers having the orientation shown in FIG. 10, is inverted before being placed into a welding fixture and then welded using a laser welder. Useful lasers for welding include those having wavelengths in the infrared spectrum (CO₂, ND:YAG) to those having wavelengths in the visible spectrum (green laser). The laser welder can be pulsed or continuous wave as long as the power and pulse duration is suitable for melting metals as compared to ablation or drilling.

After welding, the stack ejector assembly 81 is used to apply uniform load to eject the welded stacked metal foil layers from the stacking nest. FIG. 10 shows a partially assembled fixture assembly with excess tab material from tabs 18 extending from the channels 83 of the stacking nest 88.

One skilled in the art will appreciate that the present invention can be practiced with embodiments other than those disclosed. The disclosed embodiments are presented for purposes of illustration and not limitation, and the present invention is limited only by the claims that follow.

1. A method comprising
stacking a plurality of metal foil layers to form a metal foil layer stack, the metal foil layer stack having a width, a length, and a metal foil layer stack edge;
sandwiching the metal foil layer stack between top and bottom end plates, each end plate having a length, a width, and a thickness defining an edge, the thickness of each end plate being at least 20 micrometers thick;
aligning the edges of the top and bottom end plates with the edge of the metal foil layer stack and pressing or compressing the metal foil layers together between the top and bottom end plates; and
welding the metal foil layer stack and the top and bottom end plates together using a penetration weld.

2. The method of claim 1 wherein the metal foil layers are made from a metal comprising copper, aluminum nickel, titanium or alloys thereof.

3. The method of claim 1 wherein the end plates are made from a metal comprising titanium, vanadium, aluminum, nickel or alloys thereof.

4. The method of claim 1 wherein the length of the metal foil layers is greater than the width of the metal foil layers.

5. The method of claim 1 wherein the length of the top and bottom end plates is greater than the width of the end plates.

6. The method of claim 1 further comprising welding the edges of the top and bottom end plates and the edge of the metal foil layer stack.

7. The method of claim 1 further comprising cutting the metal foil layer stack to form a metal foil layer stack edge wherein cut edges of the plurality of metal foil layers are aligned.

8. The method of claim 1 wherein the penetration weld is a laser penetration weld.

9. The method of claim 1 wherein the metal foil layer stack comprises a stack of electrode tabs connected to electrodes which form an electrode stack.

10. The method of claim 9 further comprising securing the electrode stack with an insulative barrier.

11. The method of claim 1 further comprising attaching a feedthrough pin to the end plates that are welded together and to the metal foil layer stack.

12. The method of claim 1 wherein the metal foil layer stack is inverted before welding the metal foil layer stack and the top and bottom end plates together.

13. The method of claim 1 wherein each metal foil layer is partially coated with a coating.

14. The method of claim 1 wherein the thickness of each metal foil layer ranges from 5 micrometers to 40 micrometers.

15. The method of claim 13 wherein the thickness of the coating layer ranges from 25 micrometers to 250 micrometers.
